(19) United States
(12) Patent Application Publication
(10) Pub. No.: US 2019/0079898 A1
(43) Pub. Date: Mar. 14, 2019

(54) DISTRIBUTED MACHINE LEARNING PLATFORM USING FOG COMPUTING

(71) Applicant: Actiontec Electronics, Inc., Santa Clara, CA (US)

(72) Inventors: Bo XIONG, San Ramon, CA (US); Dean CHANG, Sunnyvale, CA (US); Chuang LI, Saratoga, CA (US)

(73) Assignee: Actiontec Electronics, Inc., Santa Clara, CA (US)

(21) Appl. No.: 15/702,636

(22) Filed: Sep. 12, 2017

(51) Int. Cl. G06F 15/18; H04W 4/00; H04L 12/12; H04L 12/24; H04L 29/08

(52) U.S. Cl. CPC G06F 15/18; H04W 4/006; H04L 67/12; H04L 41/0853; H04L 12/12

(57) ABSTRACT

Systems and methods involving distributed machine learning using fog computing are described. The distributed machine learning architecture described involves at least a cloud server, one or more fog nodes and one or more edge devices. The cloud server has superior computational power compared to the fog nodes and edge devices and the edge devices may have inferior computational power compared to the fog nodes. The cloud server, fog nodes and edge devices may each have machine learning capability involving learning algorithms used to train models that may be used for inferencing. The distributed machine learning platform described herein may be used for making predictions and identifying certain types of data or trends in data. By distributing the machine learning computation to lower level devices, such as fog nodes and edge devices, bandwidth usage and latency common in traditional distributed systems may be reduced.

### FIELD OF THE INVENTION

The present invention relates generally to the field of machine learning and specifically relates to a machine learning system having distributed machine learning across a fog computing platform.

### BACKGROUND

With the advent of the Internet and advanced communication technologies such as Wi-Fi and Bluetooth, computing devices may now connect and communicate with one another locally and over long distances. Devices may effortlessly exchange data between one another and even benefit from the processing power of other computing devices within their communication network.

While modern communication techniques and systems permit computing devices to connect to one another, functionality requiring a significant amount of processing power is often only available on dedicated devices having powerful processors, such as cloud servers. Devices having inferior processing power, such as user devices, may rely on these superior computing devices for certain specialized functionality. For example, user devices may rely on cloud servers for machine learning functionality.

Cloud-based machine learning platforms such as Google Cloud may be used to train computers in the cloud using complex learning algorithms designed to generate models. Typically, large amounts of training data are required to produce meaningful results from such models. For a user computing device to benefit from cloud-based machine learning and receive results tailored to data specific to that device, large quantities of data must be sent to the cloud. The machine learning algorithms may be executed in the cloud based on that unique data set and results specific to the requesting device then may be shared with the lower level requesting device. As conditions change, data frequently must be sent to the cloud to receive accurate and relevant results. This iterative process is relatively time consuming and requires that a significant amount of data be sent to the cloud, resulting in undesirably high bandwidth usage and latency.

Recently, the concept of fog computing has been developed to address the challenges of traditional cloud computing architecture. Fog computing platforms may involve a cloud server, a fog node and an edge device. Fog computing moves computation traditionally found on the cloud to fog nodes that are closer to where data is generated. Any device with processing power, storage, and network connectivity may be a fog node, e.g., switches, routers, and embedded servers.

While fog computing has alleviated some of the problems associated with traditional cloud computing architecture, the lower level devices remain dependent on the cloud server for machine learning functionality. What is needed is a distributed machine learning platform that utilizes a fog computing architecture, which provides machine learning capabilities at each level of the fog computing architecture.

### SUMMARY OF THE INVENTION

The present invention is directed to distributed machine learning platforms using fog computing. The distributed platform involves cloud computing using at least a cloud server, a fog node and an edge device. The cloud server and fog nodes each have machine learning capability. The edge devices also may have machine learning capability. The platforms and methods disclosed herein are described in the context of a media content distribution system, information security system and a security surveillance system, though it is understood that the inventive distributed machine learning platform may be used for other applications.

To improve upon the traditional cloud-based machine learning platform, machine learning algorithms may be executed both on upper levels that include at least one cloud server as well as on lower levels that include at least one fog node and edge device. In this manner, the machine learning duties may be distributed across multiple devices, reducing the computation required of the cloud server at the upper level.

In accordance with one aspect of the present invention, the upper level may generate an initial model and then train that initial model in the upper level. The trained model may then be shared with the devices on the lower level. The lower level devices may execute the initial model and further train the initial model locally using learning algorithms and feedback collected locally. When necessary, the lower level devices may send feedback collected locally to the cloud server at the upper level to retrain the model using the more extensive computing resources available at the upper level. The retrained model may then be deployed to the lower level, after which iteration between the upper level and the lower level may continue to maintain and improve the quality of the model over time.

### BRIEF DESCRIPTION OF THE DRAWINGS

FIG. 1 is a view of the components of one embodiment of the distributed machine learning platform.

FIG. 2 is a schematic view of the electronic components of a fog node.

FIG. 3 is a schematic view of the electronic components of an edge device.

FIG. 4 is a view of the hierarchy of the components of the machine learning platform.

FIG. 5 is a functional diagram describing a light version of the fog computing platform.

FIG. 6 is a flow chart illustrating the data flow and decisions made in the light version of the fog computing platform.

FIG. 7 is a functional diagram describing an expanded version of the fog computing platform.

FIG. 8 is a flow chart illustrating the data flow and decisions made in the expanded version of the fog computing platform.

FIG. 9 is a view of the components of the RAID CDN system.

FIG. 10 is a view of the components of the RAID CDN network.

### DETAILED DESCRIPTION

The present invention is directed to a machine learning system having distributed machine learning across a fog computing platform. A machine learning system configured in accordance with the principles of the present invention includes at least a cloud server, one or more fog nodes, and an edge device. In addition to the cloud server, the fog nodes and the edge device are configured to execute machine learning algorithms, thereby reducing the machine learning computation required of the cloud server.

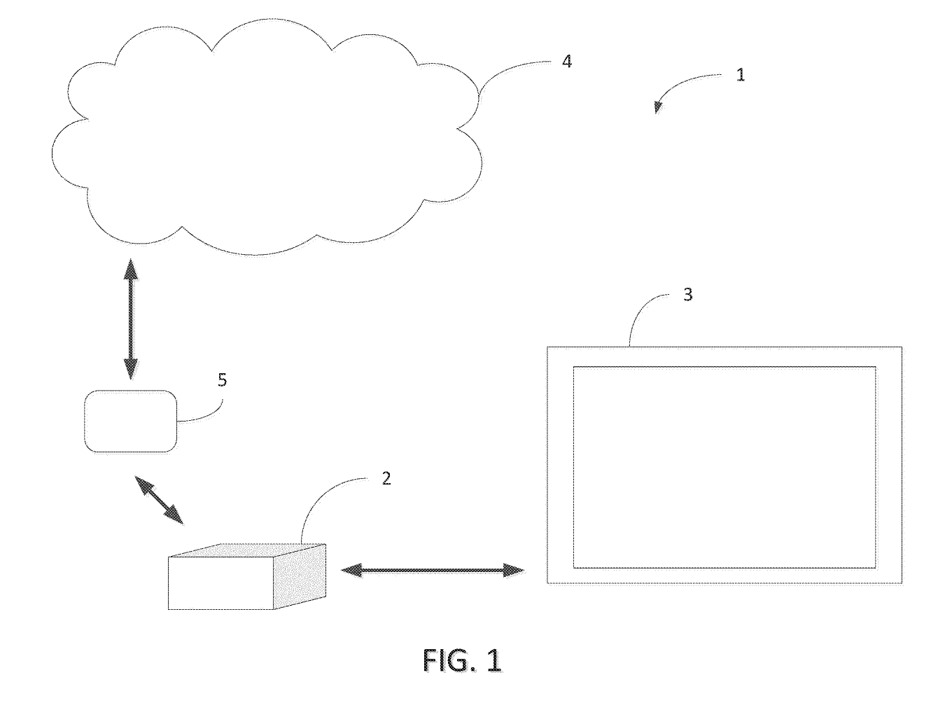

Referring to FIG. 1, distributed machine learning platform 1 is illustrated having lower level devices (i.e., fog node 2 and edge device 3) and high level devices (i.e., cloud server 4). Fog node 2 may be any device with processing power, storage, and network connectivity such as switches, routers, and embedded servers. Edge device may also be any device have processing power, storage and network connectively and may be a personal computer, laptop, tablet, smart phone or television. As is illustrated in FIG. 1, edge device 3 may be in bi-directional communication with fog node 2. Also, fog node 2, may be in bi-directional communication with cloud server 4 via router 5. Fog node 2 of distributed machine learning platform 1 may be separate and distinct from router 5 or may be combined with router 5 or may be configured such that fog node 2 may communicate with cloud server 4 directly without a router.

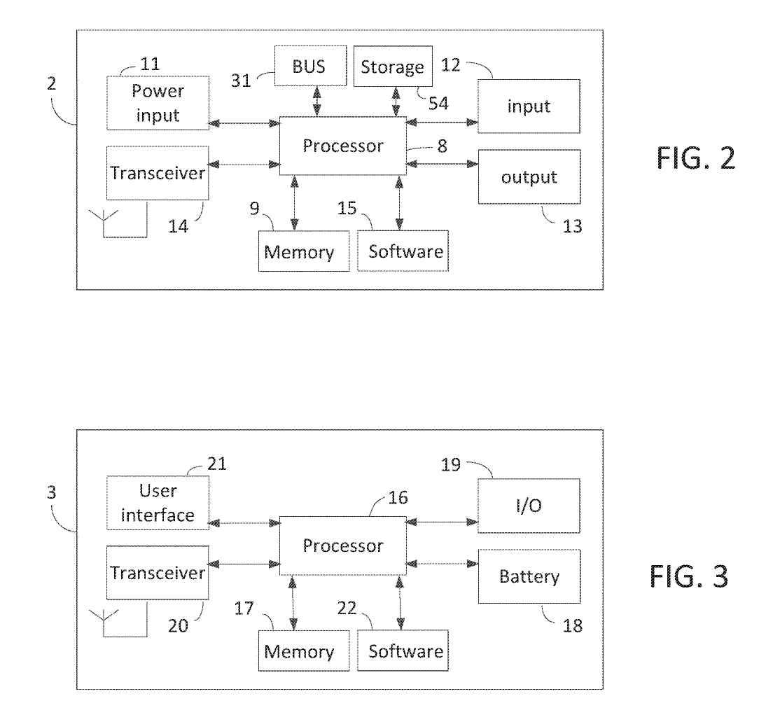

Referring now to FIG. 2, exemplary functional blocks of fog node 2 are illustrated. In particular, fog node 2 may include processor 8 coupled to memory 9, such as flash memory, electrically erasable programmable read only memory, and/or volatile memory. Processor 8 may be suitable for machine learning computation. Processor 8 may be a single processor, CPU or GPU or may be multiple processors, CPUs or GPUs, or a combination thereof. Processor 8 may also or alternatively include Artificial Intelligence (AI) accelerators configured for machine learning computation. Fog node 2 may further include BUS 31, storage 54, power input 11, input 12 and output 13. BUS 31 may facilitate data transfer. Storage 54 may be a solid state device, magnetic disk or optical disk. Power input 11 may connect fog node 2 to a wall outlet. Input 12 and output 13 may be connected to edge device 3, router 5 or another digital device. Transceiver 14 may permit fog node 2 to access the Internet and/or communicate wirelessly with router 5 and/or edge device 3. Software 15 may be non-transitory computer readable medium run on processor 8.

Referring now to FIG. 3, exemplary functional blocks of edge device 3 are illustrated. In particular, edge device 3 may include processor 16 coupled to memory 17, such as flash memory, electrically erasable programmable read only memory, and/or volatile memory. Processor 16 may be suitable for machine learning computation. Edge device 3 may further include battery 18 as well as input/output 19 and user interface 21. In embodiments where edge device 3 does not include battery 18, edge device 3 may alternatively receive power from a wall outlet. Transceiver 20 may permit edge device 3 to access the Internet and/or communicate wirelessly with router 5 and/or fog node 2. Software 22 may be non-transitory computer readable medium run on processor 16.

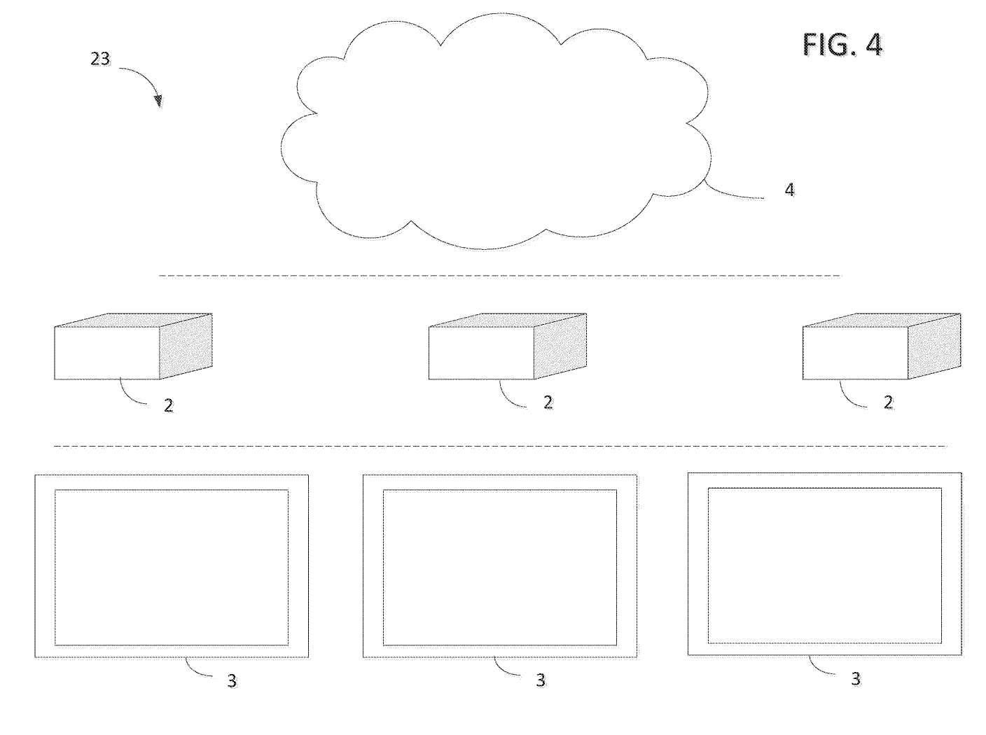

Distributed machine learning platform 1, having components described in FIGS. 1-3, may be used by a user, using edge device 3, to distribute desired or relevant information in a manner more efficient and more reliable than traditional information systems by implementing fog computing having machine learning functionality to lower level devices, i.e. fog node 2 and edge device 3. Referring now to FIG. 4, the fog computation hierarchy having edge device 3, fog node 2 and cloud server 4 is illustrated.

As is illustrated in FIG. 4, fog computing platform 23 involves one or more edge devices 3, one or more fog nodes 2 and cloud server 4. Cloud server 4 has machine learning capability and is configured to train a model as well as generate inferencing. Fog nodes 2 may have limited machine learning capability, including a limited ability to train data, as well as some inferencing functionality. Edge devices 3 also may have some limited machine learning capability, including the ability to train a model and some inferencing functionality, though the machine learning ability of edge devices 3 may be inferior to that of fog nodes 2.

Edge devices 3 may send data to, and receive data from, other components of fog computing platform 23, such as fog nodes 2 and cloud server 4. As explained above, edge devices 3 may include personal computers, laptops, tablets, smart phones or televisions, combinations thereof, or may be any other computing device having a processor and storage. Like edge devices 3, fog nodes 2 may be able to send data to, and receive data from, other components of fog computing platform 23, including edge devices 3 and cloud server 4. As explained above, fog node 2 may be a switch, router or embedded server or may be any other computing device having a processor and storage. Like edge device 3 and fog node 2, cloud server 4 may send data and receive data from other components of fog computing platform 23. Cloud server 4 may be a cloud server or other cloud based computing system.

In the manner described above, and illustrated in FIG. 4, fog computing platform 23 preferably includes at least two levels. One level, referred to herein as the lower level, includes edge devices 3 and fog nodes 2. The second level, referred to herein as the upper level, comprises cloud server 4. The upper level is designed to contain more powerful computing resources and preferably is centralized, whereas the lower level includes less powerful computing resources, but is distributed. To conserve network bandwidth and minimize latency, machine learning computation may be done at the lower level, i.e. at edge devices 3 and fog nodes 2, to the extent possible without sacrificing quality or performance of the system.

While the lower level may be tasked with machine learning computation as much as possible, the upper level having the cloud server, may be tasked with providing support to the lower level when the computation resources at the lower level are deemed insufficient, for example, when the latency exceeds a predetermined period. As the upper level includes more powerful computing resources, computation at the upper level may involve additional data inputs. For example, algorithms that may be run on at cloud server 4 may be more extensive and designed to consider far greater volumes of, and different types of, data. Additionally, databases stored at cloud server 4 may be much larger than databases stored locally at the lower level on fog nodes 2 or edge devices 3.

Referring still to FIG. 4, each level of fog computing platform 23 is scalable by adding additional edge devices 3, fog nodes 2, and/or cloud servers 4. With the addition of more devices, the capability of the platform at each level may be expanded. In addition to each level being scalable by adding more devices, more levels may be added to fog computing platform 23 to expand its capabilities. For example, a second cloud server may be added as an additional intermediate layer to reduce the communication distance between fog nodes 2 and cloud server 4.

Fog computing platform 23 further may be tailored to a particular application by assigning a hierarchy within levels of the platform. For example, cloud server 4 may identify and assign a particular edge device and/or a particular fog node as a supervisor. As explained in more detail below, edge devices 3 and fog nodes 2 may develop and evolve based on local data. Accordingly, some edge devices 3 and fog nodes 2 may develop models that are more evolved or otherwise more accurate (i.e. better) than others. The devices with better models may be treated as supervisor devices. In this configuration, the supervisor device may provide the lower level devices having inferior models with the models of the supervisor devices that are more evolved or more accurate. Accordingly, a supervisor device may select for inferior devices the machine learning model to be used by the inferior devices. Also, cloud server 4 may request and receive a copy of a locally trained machine learning model from edge devices 3 and/or fog nodes 2 that have developed better machine learning models.

The computing power of each device also may influence the hierarchy of fog computing platform 23. For example, the computing power of fog nodes 2 may differ from one fog node to another, e.g., newer fog nodes may have superior computing power with more advanced technology. A plurality of different models and/or learning algorithms may be available to the fog nodes, each having different computing power requirements. The machine learning algorithms and/or models used by or selected for fog nodes on the same level may thus be tailored accordingly to their different computing power. In this manner, some fog nodes may be capable of running more complex models and/or learning algorithms than other fog nodes. Similarly, edge devices 3 and cloud servers 4 may have varying computing power and thus the learning algorithms and/or models used by edge devices 3 and cloud servers 4 similarly may be tailored according to their computing power.

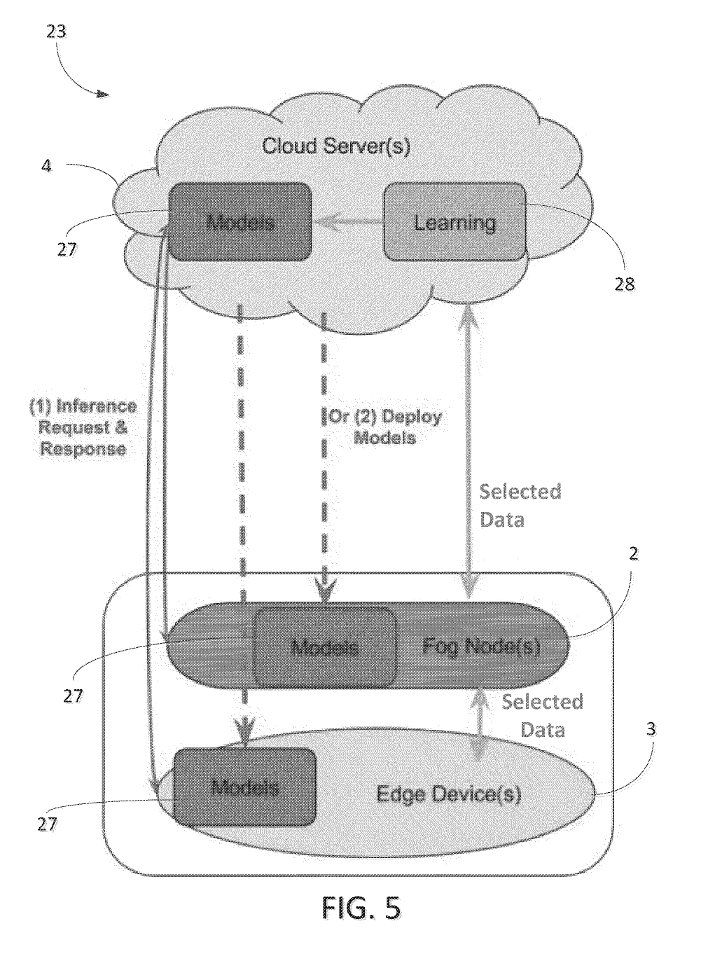

Referring now to FIG. 5, a functional diagram of a light version of fog computing platform 23 is illustrated. Specifically, FIG. 5 shows edge device 3, fog node 2, and cloud server 4. As is illustrated in FIG. 4, cloud server 4 has learning algorithms and may run model 27. Learning algorithms 28 may be used to generate model 27 and train model 27. Lower level devices may run models 27 but do not have the ability to generate or train models 27.

As is shown in FIG. 5, models generated by cloud server 4 may be shared with fog node 2 and edge device 3. Also, data may be sent from edge device 3 to fog node 2 and from fog node 2 to cloud server 4. Data received from fog node 2 may be used by cloud server 4 for learning purposes. Specifically, at cloud server 4 computers may be trained and retrained using the data received from fog node 2. Learning algorithms may be run over the data ultimately resulting in new or updated models 27 that may be shared with fog node 2 and edge device 3 and may be used for inferencing.

In accordance with one aspect of the configuration disclosed in FIG. 5, edge device 3 and/or fog node 2 may run inferencing locally, thus distributing computation to the lower level. By running inferencing locally, network bandwidth may be conserved and latency of the system may be reduced. Alternatively, edge device 3 and/or fog node 2 may request that cloud server 4 provide an inference if edge device 3 and/or fog node 2 is not confident in the local inference or otherwise questions the accuracy of the local inference.

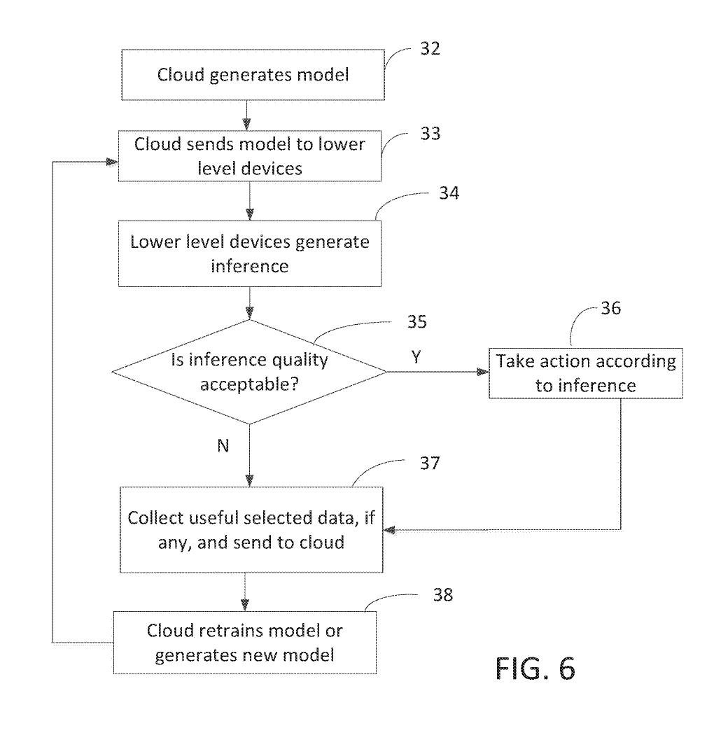

Referring now to FIG. 6, a flowchart detailing the data flow and decisions made in FIG. 5 is described. At step 32, cloud server 4 may generate a model trained on historical data or data related to user preferences, user characteristics and/or other relevant data. At step 33, cloud server 4 sends the model to lower level devices, including fog node 2 and/or edge device 3. At step 34, lower level device generate an inference based on the model received from cloud server 4. At decision 35, lower level devices—fog node 2 and/or edge device 3—may decide whether the inference quality is acceptable. Decision 35 may be made by monitoring data distribution, monitoring the confidence level of inferences, and/or testing the model with unused historical data, all three of which are discussed in greater detail below.

Monitoring data distribution may involve descriptive statistics to evaluate data distributions. For example, if the model was trained on training data with a distribution that differs substantially from the data that the model encounters in real use, then the model may not work well. When this happens, additional recent data is required to train the model for real use.

Monitoring confidence level of inferences may involve monitoring the confidence interval. The confidence interval is calculated to describe the amount of uncertainty associated with a sample estimate and involves analyzing and estimating an error rate of the model. Additionally, the confidence interval may refer to a confidence level associated with the inferences generated by the model. It should be well understood by one in the art of machine learning that there are many different ways to calculate the confidence based on different assumptions and machine learning algorithms used. For example, a Bayesian machine learning model has confidence intervals built in, while a support vector machine learning model needs external methods such as resampling to estimate confidence interval.

Testing with unused historical data also may be used to evaluate an inference and involves running historical data that was not used in training the model. With this set of historical data, an outcome or result relevant to the data may already be known and may be compared to the outcome or result generated by the model using the historical data. Accordingly, the historical data may be used as a proxy for how well a model may perform on similar future data.

Should it be determined at decision 35 that the inference quality is acceptable, i.e., a high quality inference is generated, and a new model is not required, at step 36 the lower level devices may take action according to the inference. After taking action according to the inference generated, or if it is determined at decision 35 that the inference quality is not acceptable, selected data or information may be collected based on the action taken or the unacceptable inference and sent to cloud server 4 at step 37. This data or information may be useful to the cloud despite the action taken being correct, if for example, the selected data or information helps cloud server 4 train better models or helps cloud server 4 determine that the model used by the lower level device may be generalized to more diverse cases. However, this data or information may not be useful if the current model has a very high degree confidence in making good inferences. At step 38, cloud server 4 may receive the selected data and retrain the model using learning algorithms or generate a new model using the received data or other more relevant data. The process then starts over again at step 33, where the cloud sends the retrained or new model generated using the received data or other relevant data to the lower level devices.

One application of the fog computing platform described in FIG. 6 is in the context of media content distribution, wherein fog node 2 may be a digital media player, cloud server 4 may be a cloud based media streaming service and edge device 3 may be a user device, such as a tablet. In the content distribution application, a cloud based media streaming service will generate an initial model at the cloud server for predicting media content that a user may be interested in watching. The initial model may be based on preferences identified by the user, user demographics and/or historical data. The general model generated at step 32 may be passed to lower level devices at step 33, including a digital media player. The lower level devices may generate an inference at step 34 based on the model, which may involve suggested media content.

At decision 35 the lower level devices may consider whether this suggested media content is acceptable by monitoring data distribution, monitoring the confidence level of inferences, and/or testing with unused historical data. If deemed acceptable, at step 36 the suggested media content may be shared with the user using the user device. After sharing the suggested media content with the user at step 36, or if the suggested media content is determined to not be acceptable at decision 35, the lower level devices may collect any useful data regarding the correct action taken, or the unacceptable suggested media content, and send this data to the cloud. At step 38, the cloud service may retrain the model based on the new data received and the process may start over at step 33.

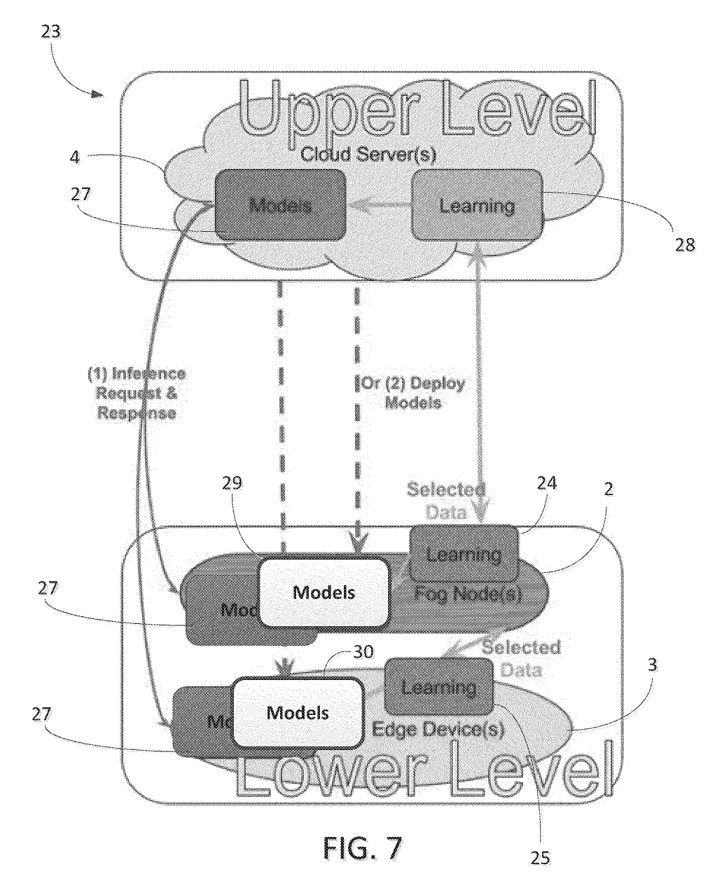

Referring now to FIG. 7, a functional diagram of fog computing platform 23 having expanded machine learning capability is illustrated. Specifically, FIG. 7 shows edge device 3, fog node 2, and cloud server 4. Like the limited version fog computing platform 23 illustrated in FIG. 5, cloud server 4 of the expanded version fog computing platform 23 has learning algorithms 28 that may be used to generate model 27 and train model 27. However, unlike the limited version fog computing platform 23, fog node 2 and edge devices 3 in expanded version of fog computing platform 23 also have learning algorithms. Specifically, fog node 2 may have learning algorithm 24 and edge device 3 may have learning algorithm 25.

Like in the limited version of fog computing platform 23 described in FIG. 5, learning algorithms 28 may be used to generate model 27 and train model 27. Models generated by cloud server 4 may then be shared with fog node 2 and edge device 3. Models 27 received from cloud server 4 may be used as default models. Using the default models received from cloud server 4, edge devices 3 and fog nodes 2 run model 27 and take actions consistent with the inferences made. From the actions taken, new data may be generated. As new data is received by edge devices 3 and/or fog nodes 2, fog node 2 may apply learning algorithms 24 and/or edge device 3 may apply learning algorithms 25 to further train and update models 27 and even generate new models 29 and 30, respectively, with improved inferencing results over models 27.

While fog nodes 2 and edge devices 3 may update model 27 and generate their own models, the computing power of the lower level is generally expected to be inferior to that of cloud server 4. Accordingly, in some instances, model 27 and/or models 29 and 30 may not be sufficient to achieve inferences of a certain quality. Should it be determined that the inferences generated at the lower level are not of sufficient quality, e.g., as determined by monitoring data distribution, monitoring the confidence level of inferences, and/or testing the model with unused historical data, certain data collected by fog nodes and/or edge devices may be sent from the lower level devices to cloud server 4. The lower level devices may either request a new inference from cloud server 4 and/or request an updated or new model. Using machine learning capability, the lower level devices may identify data that is helpful in improving the inference quality and may include this data as part of the selected data sent to cloud server 4.

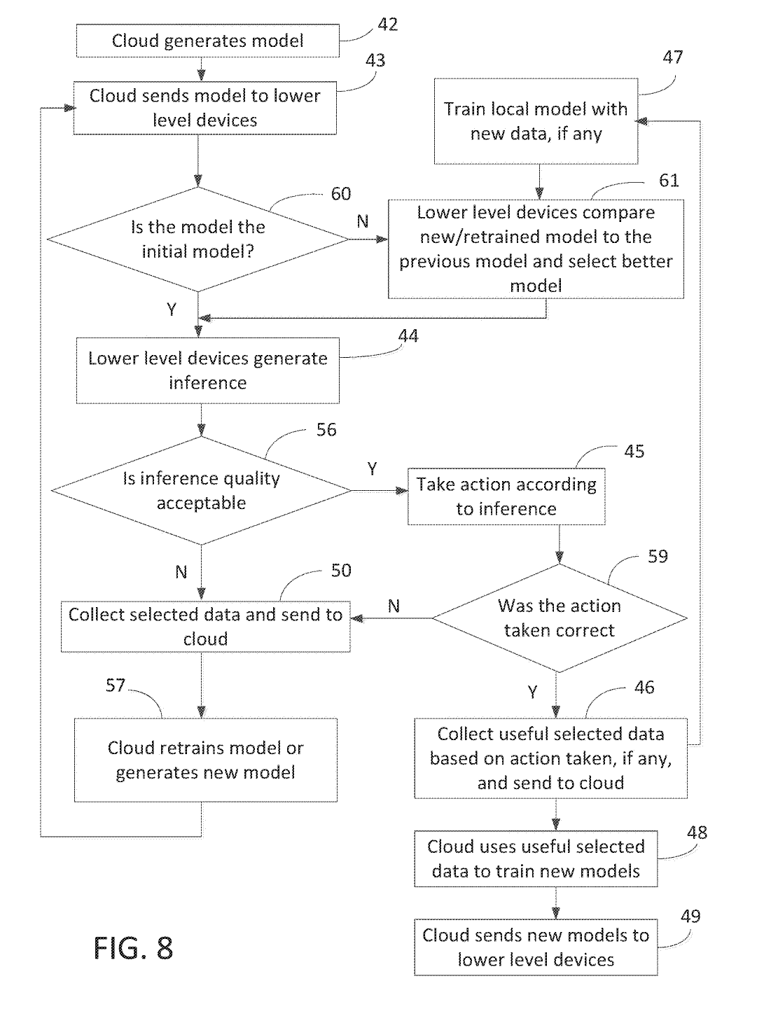

Referring now to FIG. 8, a flowchart detailing the data flow and decisions made in FIG. 7 is described. At step 42, cloud server 4 generates a model that may be trained on historical data or data related to user preferences, user characteristics and/or other relevant data. At step 43, cloud server 4 sends the model to lower level devices, including fog node 2 and/or edge device 3. At decision 60, lower level devices may determine whether or not this is the initial model received from the cloud, or if the model is a retrained or new model. The initial model may be the first model sent ever sent to the lower level device. If the model is a retrained or new model, then at step 61, the lower level device may compare the new or retrained model to the model previously used by the lower level device and select the model better for continued use, i.e. the preferred model. The lower level devices may compare models using any commonly known model evaluation approach, including applying withheld data not used to train either model. After selecting the better model between the previous model and the new/retrained model at step 61, or after determining the model is the initial model at decision 60, lower level devices may then generate an inference at step 44 using the initial model or the model determined to be better at step 61. Cloud server may also, optionally, demand that a lower level device use a new model, thereby bypassing decision 60 and step 61.

At decision 56, lower level devices, fog node 2 and/or edge device 3, may decide whether the inference quality is acceptable. As described above with respect to FIG. 6, consideration of whether the inference quality is acceptable may involve monitoring data distribution, monitoring the confidence level of inferences, and/or testing with unused historical data. If it is determined at decision 56 that the inference quality is not acceptable, selected data or information such as inputs and outputs of the inference may be collected and sent to the cloud server 4 at step 50, and the cloud at step 57 may retrain the model based on more recent data/information or data/information otherwise deemed to be more appropriate. Alternatively, at step 57, the cloud may generate an entirely new model. After generating a new model or retraining the previous model, the process may start all over again at step 43, wherein the model is sent to the lower level device(s).

If however, it is determined at decision 56 that the inference quality is acceptable, i.e., a high quality inference is generated, at step 45 action may be taken according to the inference generated. Upon taking action according to the inference generated, at decision 59 it must be determined whether the action taken was correct. For example, where the action taken was a prediction and data/information collected subsequent to the action taken indicated that the prediction was not correct, then it will be determined that the action taken was not correct. On the other hand, if the data indicated that the prediction was indeed correct, the action taken will be deemed to have been correct.

If it is determined at decision 59 that the action taken was not correct, then at step 50 selected data or information that is relevant to the action taken, or that otherwise may be useful to cloud server 4 to generate a better model, is collected and sent to cloud server 4. Subsequently, at step 57, data or information collected in step 50 and/or other relevant data or information may be used by the cloud server 4 to retrain the model or develop a new model. Subsequently, the cloud sends the retrained or new model to lower level devices and the process may start over again at step 43.

Data usefulness machine learning models may be developed by the cloud to predict usefulness of data or information collected by lower level devices. If the data or information collected by the lower level devices is deemed to be useful for retraining models, that data may be selected (i.e., selected data) to be sent to the cloud to retrain the prediction models as explained above. Using learning algorithms, over time the cloud may learn which data or information collected by the lower level devices is most useful for retraining models to generate better inferences. This may involve dividing the data or information received from the lower level devices into distinct classes of data and using this data or information to retrain the machine learning models or generate new machine learning models. The quality of the inferences generated by the retrained or new machine learning models may be evaluated and, through examining the quality of the inferences generated, it may be determined what types of data classes result in the highest quality inferences. The cloud may provide the lower level device with the data usefulness machine learning model trained to select data or information falling under the data or information classes deemed to be most useful. The cloud may continue to refine the data usefulness machine learning model over time and may send updated models to the lower level devices. In this manner, the lower level devices may make the determination of whether the collected data or information is useful and the selection of “useful” data may be continually improved as the model improves.

If instead it is determined at decision 59 that that the action taken was correct, then at step 46, the lower level device collects useful selected data or information based on the action taken, if such useful selected data or information exists. The process described above for generating a model at the cloud for determining useful data and sharing the model with lower level devices may be implemented here. Data or information relating to the action taken may be useful despite the action taken being correct. For example, data may reveal that certain parameters are better indicators than others. Also, this data or information may help the cloud train better models. Data or information collected relating the correct action taken also may suggest that certain models may be generalized to more diverse cases.

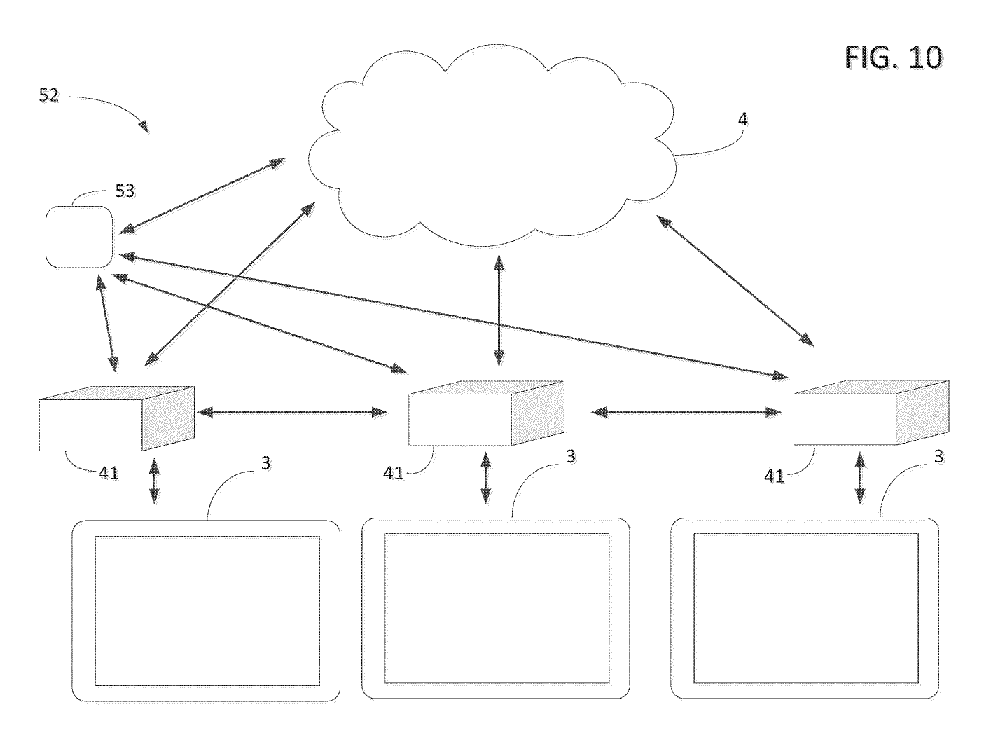

At step 46, the lower level device sends this data or information to the cloud. At step 48, the cloud may use the selected data or information to train a new model or retrain a model which, at step 49, is distributed to other lower level devices within the network illustrated in FIG. 10. Similarly, in the context of the network illustrated in FIG. 10, the cloud may receive other data or information from other lower level devices and train a new model based on the data or information from the other lower level devices. This new model may be distributed to the lower level device at step 42 and the process may start all over again.

The selected data or information collected at step 46 also may be used at step 47 by the lower level device to retrain the model using learning algorithms. In this way, the same data or information collected by the lower level device may be used to retrain the model locally and retrain a model at the cloud for use by other devices. Upon retraining the model at step 47, at step 61 the lower level device may compare the new or retrained model to the model previously used by the lower level device and select the better model for continued use, referred to herein as the preferred model. The lower level devices may compare models using any commonly known model evaluation approach, including applying withheld data or information not used to train either model.

After selecting the better model between the previous model or new/retrained model at step 61, or after determining that the model is the initial model at decision 60, lower level devices may then at step 44 generate an inference using the initial model or selected model and the process may start over again. In some embodiments, step 47 may be skipped and the same model that resulted in correct action being taken may be used to generate an inference at step 44.

In some embodiments, lower level devices—fog node 2 and edge device 3—may share the foregoing responsibilities and coordinate between themselves to determine which device will perform certain tasks. For example, fog node 2 may generate an inference and determine if the inference quality is acceptable. If the inference quality is acceptable, i.e., a high quality inference is generated, then fog node 2 may instruct edge device 3 to take action according to the inference generated.

Fog computing platform 23 of FIG. 8 may be particularly well suited for media content distribution. In the media content distribution application, a cloud based media streaming service will generate an initial model at the cloud server for predicting media content that a user may be interested in watching. The initial model may be based on preferences identified by the user or user demographics. The initial model generated at step 42 may be passed to lower level devices at step 43 including a digital media player. The lower level devices may determine that this is the initial model and thus may generate an inference at step 44 involving suggested media content. At decision 56 the lower level devices may consider whether this suggested media content is acceptable by monitoring data distribution, monitoring the confidence level of inferences, and/or testing with unused historical data.

If it is determined at decision 56 that the quality of the inference is unacceptable, selected data, such as inputs and outputs of the inference, may be collected and sent to cloud, then at step 57, the cloud may retrain the model or generate a new model. However, if the inference is deemed to be acceptable, at step 45 action may be taken by sharing the suggested media content with the user. At decision 59, the lower level devices may then determine, based on a user's actions, whether the predicted content was accurate. This may involve determining whether the user watched the recommended content and for how long. If it is determined that the action taken was not correct, i.e. the user did not watch the recommended content, the lower level devices may collect selected data based on the action taken by the user and send this data to the cloud at step 50. Subsequently, at step 57 the cloud may retrain the model or generate a new model, and the process starts over again at step 43.

Alternatively, if it is determined at decision 59 that the predicted content was indeed accurate, i.e. the user watched the recommended content, selected data that may be helpful or useful for training the local model may be collected at step 46, if any, and at step 47 the local model may be retrained using the most recent data on the accurately recommended content. At step 61 it may be determined that the retrained model is better than the previous model and thus an inference may be generated using the retrained model and the process may start over at step 44. At step 46, the selected data collected also may be sent to cloud server 4, which may use the data to retrain or train other models at step 48 that may be distributed to other users.

Fog computing platform 23 may also be well suited for other applications such as information security. For example, fog computing platform 23 may be used to generate an alarm that an information security threat exists. Examples of information security threats include confidential documents being sent to unauthorized outsiders or a hacker accessing or controlling network resources. In the information security context, data from local network traffic may be collected. Data from local network traffic that resulted in a security breach may be used by the cloud to train a model to detect security breaches using learning algorithms. The model may be shared with fog nodes such as routers, for example, to detect abnormal local network traffic by executing the trained models and generating inferences. The action taken described in FIGS. 6 and 8 may be an alert that a security threat is detected. The alert may be sent to an administrator using an edge device that may then confirm the threat or identify it as a false alarm. This feedback may be used to update and better train the models either locally or at the cloud.

Yet another application of fog computing platform 23 may be in the context of detecting security threats based on video data from surveillance cameras. Cameras may be in data communication with fog nodes, such as routers, that receive video data. As in the above applications, the cloud may generate an initial model based on video data related to known security threats. The initial model may be shared with the fog nodes and executed by the fog nodes to detect security threats in video data received from the camera. The actions taken described in FIGS. 6 and 8 may be an alert that a security threat is detected. The alert may be sent to an administrator using an edge device, which then confirms the threat or identifies it as a false alarm. This feedback may be used to update and better train the models either locally or at the cloud.

Permitting fog node 2 and edge devices 3 to develop models 29 and 30 based on local data, and thus evolve over time, may undesirably bias the model in favor of new data, which may cause the model to deviate too far from the original default model. In this situation, new data may diminish the overall inference quality over time and thus the evolved model may be inferior to the default model. In this scenario, cloud server 4 may cause lower level devices to restore the default model or even restore a prior version of the lower level models 29 and 30 when inference quality is determined to be decreasing.

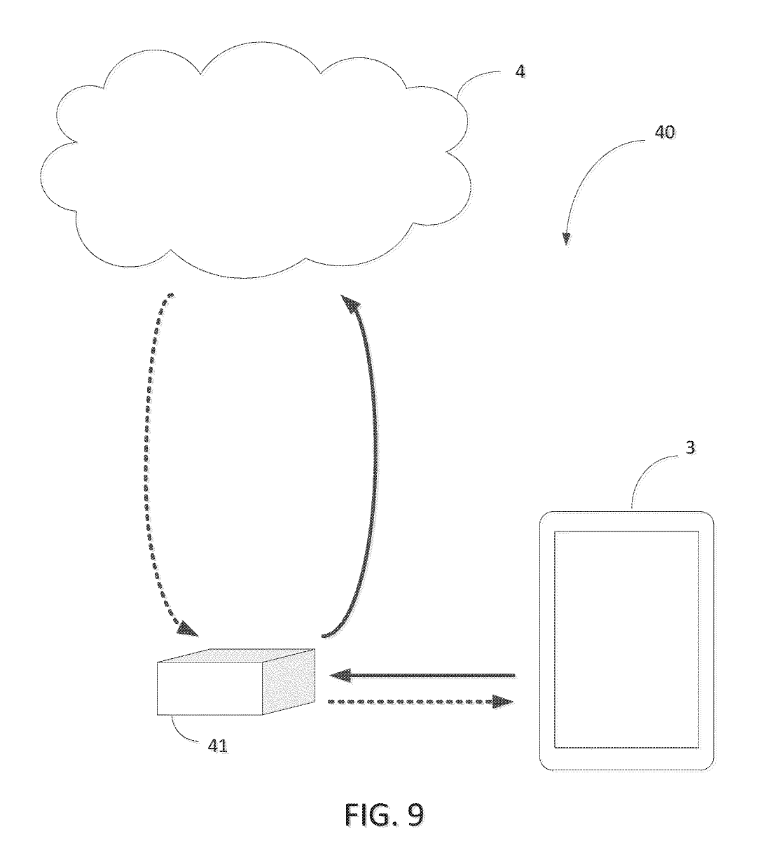

Referring now to FIG. 9, RAID CDN 40 is illustrated, which is a media content distribution embodiment of the distributed machine learning system. In this configuration, RAID box 41 together with cloud server 4 and at least one edge device 3 may form RAID CDN 40. In RAID CDN 40, the fog computing architecture illustrated in FIG. 4 is utilized, wherein RAID box 41 is a fog node. RAID box 41 may be used to provide media content such as movies, television shows, music videos, news clips, sports clips and various other media content from cloud server 4 to edge device 3. RAID CDN 40 may comprise just a small portion of the much larger RAID CDN network 52 illustrated in FIG. 10. As discussed in more detail below, RAID CDN 40 may be used for a variety of different purposes including generating an attractive content list for users, strategically storing popular content and selecting the content sources that provide content requested by the user. Edge device 3, through RAID Box 41, communicates with cloud server 4 to access media content streaming websites and/or libraries of media content that may be accessed using the Internet. By selecting media content using edge device 3 in communication with RAID box 41, a user may watch media content on edge device 3.

RAID box 41 may have the same functionality as edge device 3 and fog node 2 in both the limited and the expanded version of fog computing platform 23, shown in FIGS. 5 and 7, respectively. Accordingly, RAID box 41 may be a digital media player having the components described in FIG. 2 and additionally may have router functionality. RAID box 41 may communicate directly with cloud server 4 or may communicate with cloud server 4 via a router. RAID box 41, also may communicate with edge device 3 via a wireless or wired connection.

Cloud server 4 of RAID CDN 40 may generate models, have learning functionality, and make inferences consistent with cloud server 4 described above. The computing power of cloud server 4 exceeds that of both RAID box 41 and edge device 3. RAID box 41 too may generate models, have learning functionality and make inferences, though the computing and machine learning ability of RAID box 41 may be inferior to that of cloud server 4. Also, edge device 3 may generate models, have learning functionality and make inferences, though the computing and machine learning ability of edge device 3 may be inferior to that of RAID Box 41. Cloud server 4, having superior computing power, may be able to consider greater amounts of data and greater numbers of variables than RAID box 41, and RAID box 41 may be able to consider more data input and variables than edge device 3. Typically, the accuracy of the inferences generated by any given model may be improved by the quantity of data input and the types of used to train the model.

RAID CDN 40 may operate similar to the limited version of fog computing platform 23 illustrated in FIGS. 5 and 6 or the expanded version of fog computing platform 23 illustrated in FIGS. 7 and 8. Specifically, models may be initially trained by cloud server 4 and provided to RAID box 41 and/or edge device 3. The models initially generated by cloud server 4 may be trained using historical data or otherwise generated based on user characteristics. The original model or default model generated by cloud server 4 may be sent to RAID box 41 and/or edge device 3. Alternatively, as explained below, RAID box 41 may be included in a network having additional RAID boxes and as such models used by other RAID boxes may be shared with and used by RAID box 41 and/or edge devices 3. Different RAID boxes 41 may have different computing power, e.g., newer versions of RAID boxes 41 may have advanced computing power. As explained above, the models and learning algorithms used by a device may differ according to the computing power of that device. RAID box 41, having advanced computing power, may run a more powerful model and more complex learning algorithm than a RAID box having inferior computing power.

Upon receiving a model from cloud server 4, RAID box 41 and/or edge device 3 may execute the model and take action according to the inference. After executing the model, data may be collected based on user activity and/or system response. RAID box 41 and/or edge device 3 then may decide whether the inferences being generated by the model are of an acceptable quality according to the methods described above. If the quality of the inferences is acceptable, RAID box 41 and/or edge device 3 may continue to use the model. However, in the limited version of fog computing platform 23, if the inferences are deemed to be unacceptable, some or all of the data collected by RAID box 41 and/or edge device 3 may be sent to the cloud to generate a better model. In the expanded version of fog computing platform 23, the data generated may continuously be used to update the local model on RAID box 41 and/or edge device 3, but if an inference is deemed to be unacceptable, RAID box 41 and/or edge device 3 may send some or all of the data collected to cloud server 4 to refine the current model or generate a new model based on the new data.

Referring now to FIG. 10, RAID CDN network 52 may include multiple RAID boxes 41, multiple edge devices 3 and at least one cloud server 4. In RAID CDN network 52, a particular edge device may communicate with a particular RAID box and that particular RAID box may communicate with cloud server. Additionally, each RAID box may communicate with one or more other RAID boxes in RAID CDN network 52. In some embodiments, each edge device 3 may communicate with other edge devices and/or other RAID boxes. Using RAID CDN network 52, content providers may save bandwidth cost and improve quality of service by employing the distributed machine learning functionality described above. Both providers and viewers will benefit from RAID CDN's improved distribution service which involves generating an attractive content list for users, strategically storing popular content in RAID boxes 41 and/or selecting the best RAID boxes 41 to provide content requested by the user.

As mentioned above, the system described herein may be used to ultimately generate an attractive content list for each user. The attractive content list may be tailored to each user and may be displayed to the user on edge device 3. The attractive content list may include a list of content that RAID CDN 40 predicts the user will be interested in watching. Using the machine learning techniques described above, RAID CDN 40 may generate the attractive content list based on historical viewing patterns and/or other characteristics of user including geographic location, viewing time and self-identified information. The content presented to the user represents content that RAID CDN 40 has predicted would have the highest likelihood of being watched by the user for the longest time. This may be referred to as content having the highest predicted click rate and predicted watch time.

When the system described herein is used to generate an attractive content list, cloud server 4 will develop a pre-trained default model that may be loaded on to each device in RAID CDN network 52 illustrated in FIG. 10 which may include multiple RAID boxes 41 and/or multiple edge devices 3. The pre-trained default model sent to each RAID box 41 and/or edge device 3 may be specific to that user, specific to a particular region, or may be tailored to certain user characteristics. Upon receiving the model, RAID box 41 may execute the model to generate an attractive content list.

Data may be collected by RAID box 41 from edge device 3 regarding the type of media content actually selected for viewing, how much media content was watched, media content looked at by the user but not selected for viewing, media content selected for viewing but not actually viewed in its entirety, the time at which the media content is viewed, the geographic location of the user, and any other data that may be retrieved from edge device 3 and relevant to the attractive content list. The type of media content may include the genre, the title, actors, director, producer, studio or broadcasting company, era, release date, country of origin, geographic location in content, subject or event in content, and any other data regarding the type of media content that may be relevant to the attractive content list.

Edge device 3 may share this information with RAID box 41 or RAID box 41 may collect this information as it distributes content to edge device 3. The data may be used by RAID box 41 to locally train the model received from cloud server 4. Alternatively, or in addition, this data or a select sub-portion of this data determined to be useful in improving the model, may be sent to cloud server 4. Cloud server may use the data received from all RAID boxes 41 or a subset of RAID boxes 41 for improving the current model or generating a new and improved model. The local model also may be sent to cloud server 4 for accuracy verification. Upon improving the current model or generating a new model, cloud server 4 may send the improved or new model to RAID box 41.

Upon receiving the improved or new model, RAID box 41 may determine whether the model received from cloud server 4 is better than the model currently being used. As described in detail above, to determine if the model received from cloud server 4 is indeed better than the model currently being used, data not used to train either model may be applied to the model to determine which model produces better inferences. If the model from cloud server 4 is determined to be better than the local model currently being used, it will replace the current model. However, if local model is determined to be better, the local model will be restored. The communication loop between RAID boxes 41, edge devices 3 and cloud server 4 may continue on to maintain and improve quality over time.

As mentioned above, RAID CDN 40 also may be used to strategically store popular content in particular RAID boxes 41 distributed across RAID CDN network 52. Initially, cloud server 4 will develop a pre-trained default model that may be loaded on to each RAID box in RAID CDN network 52 illustrated in FIG. 10. The model initially generated by cloud server 4 may be based off historical viewing habits in a geographic area, relevant content ratings in a given area or even globally, and/or other relevant information initially known by cloud server 4 at the time the model is generated. Tracker server 53 may additionally be included in RAID CDN network 52 to keep track of the content downloaded to each RAID box. Tracker server 53 may be in communication with each RAID box as well as cloud server 4.

Based on the initial model received from cloud server 4, RAID box 41 may make inferences based on the model, identify popular content and ultimately download and store popular content on the RAID box that may be accessed and viewed by one or more edge devices. The upload bandwidth for each RAID box would preferably be consistently high such that each RAID box stores the maximum amount of content given the constraints of the device. By storing content that is popular in various RAID boxes distributed across a given geographic region, edge devices may retrieve content from the closest RAID box or RAID boxes rather than having to request content from cloud server 4. RAID boxes 41 may download the entire media content file or may alternatively download a portion of the media content file.

After each inference, data may be collected by RAID box 41 regarding the number of users accessing and viewing the data stored on RAID box 41, the most watched content by each edge device, user ratings attached to media content, the amount of users within a given vicinity of each device, viewing patterns of viewers in the vicinity of each device, and any other data that may be relevant to storing popular media content. The data generated may then be used to locally train the model received from cloud server 4. Alternatively, or in addition, this data or a select sub-portion of this data determined to be useful in improving the model, may be sent to cloud server 4. Cloud server may use the data received from all RAID boxes 41 or a subset of RAID boxes 41, as well as data received from tracker server 53, for improving the current model or generating a new and improved model. The local model also may be sent to cloud server 4 for accuracy verification and distribution to other devices. Upon improving the current model or generating a new model, cloud server 4 may send the improved or new model to RAID box 41.

Upon receiving the improved or new model, RAID box 41 may determine whether the model received from cloud server 4 is better than the model currently being used. As described in detail above, to determine if the model received from cloud server 4 is indeed better than the model currently being used, data not used to train either model may be applied to the models to determine which model produces better inferences. If the model from cloud server 4 is determined to be better than the local model currently being used, it will replace the current model. However, if local model is determined to be better, the local model or a previous version of it will be restored. The communication loop between RAID boxes 41, edge devices 3 and cloud server 4 may continue on to maintain and improve available content on RAID boxes 41 over time.

As explained above, RAID CDN 40 also may be used to select the best RAID boxes 41 to provide media content requested by a given user. Initially, cloud server 4 will develop a pre-trained default model that may be loaded on to RAID box 41 in RAID CDN network 52 illustrated in FIG. 10. The model initially generated by cloud server 4 may be based off of knowledge about the content already existing on each RAID box, user traffic data over RAID CDN network 52, or other relevant information initially known by cloud server 4 at the time the model is generated that may be helpful in generating this model. As explained above, tracker server 53 may additionally be included in RAID CDN network 52 to keep track of the content downloaded to each RAID box.

Based on the initial model received from cloud server 4 and content selected for viewing by user using edge device 3, RAID box 41 may make inferences based on the model and identify the best content source, i.e. RAID box and/or edge device 3, to provide the selected media content from. The inference may predict the time to download from each available content source and/or predict the probability of success for each available content source. Preferably, the inferences made result in a high upload bandwidth for each RAID box. Edge device 3 may ultimately take action according to the inference made and thus download the media content from the content source identified by the inference, which preferably is the content source having the minimum predicted download time and the best predicted success rate. Models also may be generated to alternatively, or additionally, consider other input data such as throughput and money spent for bandwidth used and other input data that may be useful in optimizing selection of the best content sources to download media content from.

In some cases, the media content file may be downloaded in pieces from more than one RAID box. Accordingly, the inference may direct edge device to download the entire media content file from one source or may alternatively download a portion of the media content file from multiple sources ultimately resulting in the entire media content file. The inference may alternatively and/or additionally direct edge device 3 to download media content from other edge devices or from a combination of RAID boxes and other edge devices.

After each inference, data may be collected by RAID box 41. The data collected by RAID box 41 may include the data regarding the geographic location of relevant edge device and the content source from which the content was retrieved, bandwidth data regarding the content sources involved, success/failure rate of each content source, the available memory on content source, internet connectivity regarding each content source, Internet service provider and speed for each content source, and any other data that may be relevant to selecting the best content sources to provide media content.

The data generated may then be used to locally train the model received from cloud server 4. Alternatively, or in addition, this data or a select sub-portion of this data determined to be useful in improving the model, may be sent to cloud server 4. Cloud server 4 may use the data received from all RAID boxes and/or edge devices or a subset thereof, as well as information continuously received by tracker server 53, for improving the current model or generating a new and improved model. The local model also may be sent to cloud server 4 for accuracy verification. Upon improving the current model or generating a new model, cloud server 4 may send the improved or new model to RAID box 41, edge device 3 and/or a combination of other RAID boxes and edge devices.

Upon receiving the improved or new model, RAID box 41 may determine whether the model received from cloud server 4 is better than the model currently being used. As described in detail above, to determine if the model received from cloud server 4 is indeed better than the model currently being used, data not used to train either model may be applied to the model to determine which model produces better inferences. If the model from cloud server 4 is determined to be better than the local model currently being used, it will replace the current model. However, if local model is determined to be better, the local model will be restored. The communication loop between RAID boxes 41, edge devices 3 and cloud server 4 may continue on to maintain and improve the selection of content sources over time.

In an alternative embodiment of RAID CDN network 52, RAID box 41 may include some tracker server functionality. Specifically, a plurality of RAID boxes may utilize a distributed hash table which uses a distributed key value lookup wherein the storage of the values is distributed across the plurality of RAID boxes, and each RAID box is responsible for tracking the content of a certain number of other RAID boxes. If a RAID box and RAID boxes geographically nearby do not have the requested content, tracker server 53 or RAID boxes located further away may provide the contact information of RAID boxes that may be responsible for tracking the requested content. In this manner the RAID boxes serve as tracker servers with limited functionality.

While various illustrative embodiments of the invention are described above, it will be apparent to one skilled in the art that various changes and modifications may be made therein without departing from the invention. For example, fog computing platform 23 may include additional or fewer components and may be used for applications other than media content destruction, information security and surveillance security. The appended claims are intended to cover all such changes and modifications that fall within the true spirit and scope of the invention.

1. A method of improving machine learning to generate high quality inferences, comprising:
at a lower level device, comparing a first machine learning model to a second machine learning model to select a preferred machine learning model;
generating an inference at the lower level device using the preferred machine learning model;
at the lower level device, evaluating whether the inference has a quality that is acceptable;
taking action at the lower level device in accordance with the inference generated; and
at the lower level device, evaluating whether the action was correct.

2. The method of claim 1, further comprising:
determining at the lower level device that the action was not correct;
collecting information relating to the action at the lower level device;
sending the information from the lower level device to an upper level device; and
training a new machine learning model at the upper level device with the information collected at the lower level device.

3. The method of claim 1, further comprising:
determining at the lower level device that the action was correct; and
if information relating to the action exists, collecting the information at the lower level device.

4. The method of claim 3, further comprising, determining at an upper level device that the preferred machine learning model at the lower level device generates a high quality inference and requesting that a copy of the preferred machine learning model at the lower level device be sent to the upper level device.

5. The method of claim 3, further comprising:
determining at the lower level device whether the preferred machine learning model has a high degree of confidence in making good inferences; and
sending the information relating to the action from the lower level device to an upper level device if it is determined that the preferred machine learning model does not have a high degree of confidence.

6. The method of claim 3, further comprising, at the lower level device, training the preferred machine learning model with the information to generate a retrained preferred machine learning model.

7. The method of claim 6, further comprising:
comparing the retrained preferred machine learning model to the preferred machine learning model to determine which is better and selecting a new preferred machine learning model; and
generating an inference using the new preferred machine learning model.

8. A method of improving machine learning to generate high quality inferences, comprising:
at a lower level device, comparing a first machine learning model to a second machine learning model to select a preferred machine learning model;
generating an inference at the lower level device using the preferred machine learning model;
at the lower level device, determining that the inference has a quality that is not acceptable;
collecting data at the lower level device regarding the quality of the inference; and
sending the data from the lower level device to an upper level device.

9. The method of claim 8, further comprising, at the upper level device, using the data to train a new machine learning model.

10.-17. (canceled)

18. A method of developing a data usefulness machine learning model comprising:
at a high level device, training a machine learning model;
sharing the machine learning model with a lower level device;
at the lower level device, generating an inference using the machine learning model;
at the lower level device, sending to the upper level device data about the inference or an action taken by the lower level device in accordance with the inference;
at the upper level device, dividing the data into a plurality of classes of data;
retraining the machine learning model with the plurality of classes of data to generate a plurality of retrained machine learning models; and
evaluating which one or more of the plurality of classes of data results in one or more of the plurality of retrained learning models that generates inferences that have a high level of quality.

19.-20. (canceled)

21. The method of claim 9, further comprising sending the new machine learning model to the lower level device.

22. The method of claim 21, further comprising:
generating an inference at the lower level device using the new machine learning model;
at the lower level device, evaluating whether the inference has a quality that is acceptable; and
taking action at the lower level device in accordance with the inference generated.

23. The method of claim 22, further comprising, at the lower level device, evaluating whether the action was correct.

24. The method of claim 22, further comprising:
determining at the lower level device that the action was not correct;
collecting information relating to the action at the lower level device;
sending the information from the lower level device to the upper level device; and
retraining the new machine learning model at the upper level device with the information collected at the lower level device.

25. The method of claim 22, further comprising:
determining at the lower level device that the action was correct; and
if information relating to the action exists, collecting the information at the lower level device.

26. The method of claim 25, further comprising, determining at the lower level device whether the new machine learning model has a high degree of confidence in making good inferences; and
sending the information relating to the action from the lower level device to the upper level device if it is determined that the new machine learning model does not have a high degree of confidence.

27. The method of claim 18, further comprising selecting one of the one or more of the plurality of retrained learning models that generates inferences having a high level of confidence for transmission to the lower level device.

28. The method of claim 27, further comprising sending the selected one of the one or more of the plurality of retrained learning models to the lower level device.

29. The method of claim 28, further comprising:
generating an inference at the lower level device using the selected one of the one or more of the plurality of retrained learning models;
at the lower level device, evaluating whether the inference has a quality that is acceptable; and
taking new action at the lower level device in accordance with the inference generated.

30. The method of claim 29, further comprising, at the lower level device, evaluating whether the new action was correct.
